(19) United States
(12) Patent Application Publication
(10) Pub. No.: US 2015/0169251 A1
(43) Pub. Date: Jun. 18, 2015

(54) SYSTEMS, APPARATUS, AND METHODS FOR TRANSMITTING DATA AND INSTRUCTIONS USING AN iSCSI COMMAND

(71) Applicant: CIRRUS DATA SOLUTIONS, INC., JERICHO, NY (US)

(72) Inventors: Wai LAM, Jericho, NY (US); Wayne LAM, Jericho, NY (US); Yik Shum TAM, Syosset, NY (US)

(73) Assignee: CIRRUS DATA SOLUTIONS, INC., JERICHO, NY (US)

(21) Appl. No.: 14/103,970

(22) Filed: Dec. 12, 2013

(51) Int. Cl. G06F 3/06

(52) U.S. Cl. CPC G06F 3/0641; G06F 3/0619; G06F 3/067; G06F 3/0608

(57) ABSTRACT

A data packet is generated. An instruction relating to a selected data processing operation, and information indicating that additional processing of the data packet is required, are inserted into the data packet. For example, the information may comprise a predetermined bit or a predetermined sequence of bits. In one embodiment, the information is inserted at a predetermined location within the data packet. The data packet is inserted into a selected field of an iSCSI command. For example, the data packet may be inserted into a buffer field of the iSCSI command. The iSCSI command is transmitted.

### TECHNICAL FIELD

This specification relates generally to systems and methods for storing and managing data, and more particularly to systems and methods for transmitting data and instructions using an iSCSI command.

### BACKGROUND

The storage of electronic data, and more generally, the management of electronic data, has become increasingly important. With the growth of the Internet, and of cloud computing in particular, the need for data storage capacity, and for methods of efficiently managing stored data, continue to increase. Many different types of storage devices and storage systems are currently used to store data, including disk drives, tape drives, optical disks, redundant arrays of independent disks (RAIDs), Fibre channel-based storage area networks (SANs), etc.

Data storage techniques have evolved to include a variety of different types of data storage operations, including copying data, backing up data, replicating data, synchronizing data, migrating data, etc. In some environments these operations may be performed within a single storage system or device. In other environments such operations may be performed between two or more storage systems that are physically separated and linked by one or more networks.

### SUMMARY

In accordance with an embodiment, a method of managing data is provided. A data packet is generated. An instruction relating to a selected data processing operation, and information indicating that additional processing of the data packet is required, are inserted into the data packet. For example, the information may comprise a predetermined bit or a predetermined sequence of bits. The data packet is inserted into a selected field of an iSCSI command. The iSCSI command is transmitted.

In one embodiment, the information is inserted at a predetermined location within the data packet. The data packet may be inserted into a buffer field of the iSCSI command.

In another embodiment, selected data is compressed, generating compressed data, and the compressed data is inserted into the data packet. The data packet may be encrypted.

In one embodiment, the instruction relates to one of: a compression operation, a decompression operation, a deduplication operation, a backup operation, a synchronization operation, a write operation, a copy operation, and a snapshot operation.

For example, the instruction may relate to a write operation. Second information indicating a start sector to which data is to be written is inserted into a selected field of the data packet.

In another example, the instruction may relate to a deduplication operation. Second information indicating a source sector from which data is to be deduplicated is inserted into a first selected field of the data packet, and third information indicating a start sector to which data is to be deduplicated is inserted into a second selected field of the data packet.

In accordance with another embodiment, a method of managing data is provided. An iSCSI command comprising a data packet is received. First information indicating that additional processing of the data packet is required, and second information relating to a specified data processing operation, are detected in the data packet. For example, the first information may comprise a predetermined bit or a predetermined sequence of bits. The specified data processing operation is performed, based on the second information.

In one embodiment, the data packet is located within a buffer field of the iSCSI command. In another embodiment, the first information is located at a predetermined location within the data packet.

In one embodiment, the data packet is decrypted.

The specified data processing operation may comprise one of: a compression operation, a decompression operation, a deduplication operation, a backup operation, a synchronization operation, a write operation, a copy operation, and a snapshot operation.

In one embodiment, data is retrieved from the data packet, and the specified data processing operation is performed with respect to the data, based on the second information. For example, the second information may comprise a first instruction relating to a decompression operation and a second instruction relating to a deduplication operation. A decompression operation is performed based on the first instruction, and a deduplication operation is [performed based on the second instruction.

These and other advantages of the present disclosure will be apparent to those of ordinary skill in the art by reference to the following Detailed Description and the accompanying drawings.

### BRIEF DESCRIPTION OF THE DRAWINGS

FIG. 1A shows a communication system that may be used to provide data storage services and data management services in accordance with an embodiment;

FIG. 1B shows a communication system that may be used to provide data storage services and data management services in accordance with another embodiment;

FIG. 2 shows components of a data manager in accordance with an embodiment;

FIG. 3 shows a volume of data in accordance with an embodiment;

FIG. 4 shows a copied volume in accordance with an embodiment;

FIG. 5 is a flowchart of a method of copying data using deduplication in accordance with an embodiment;

FIG. 6 shows a hash table in accordance with an embodiment;

FIG. 7 shows an exemplary iSCSI command;

FIG. 8 is a flowchart of a method of transmitting data and/or instructions using an iSCSI command in accordance with an embodiment;

FIG. 9 shows a data packet containing an instruction in accordance with an embodiment;

FIG. 10 shows an iSCSI command in accordance with an embodiment;

FIG. 11 is a flowchart of a method of managing data in accordance with an embodiment;

FIG. 12 shows a data packet containing an instruction in accordance with another embodiment;

FIG. 13 is a flowchart of a method of managing data in accordance with an embodiment;

FIG. 14 shows a data packet containing a plurality of instructions in accordance with an embodiment;

FIG. 15 is a flowchart of a method of managing data in accordance with another embodiment;

FIG. 16 shows the volume of FIG. 3 after a block has been updated;

FIG. 17 is a flowchart of a method of synchronizing data in accordance with an embodiment;

FIG. 18A shows a plurality of segments defined in a data block in accordance with an embodiment;

FIG. 18B shows a hash table in accordance with an embodiment;

FIG. 19A shows a plurality of segments defined in a data block in accordance with an embodiment;

FIG. 19B shows a hash table in accordance with an embodiment;

FIG. 20 is a schematic illustration of a method of reducing data transmission requirements while copying and/or synchronizing data in accordance with an embodiment; and

FIG. 21 shows an exemplary computer that may be used to implement certain embodiments of the invention.

### DETAILED DESCRIPTION

Data storage techniques have evolved to include a variety of different types of data storage operations, including copying data, backing up data, replicating data, performing a snapshot of data, synchronizing data, migrating data, etc. In some environments these operations may be performed within a single storage system or device. In other environments such operations may be performed between two or more storage systems that are physically separated and linked by one or more networks.

If the system storing the original (source) volume and the system storing the copied (destination) volume are directly linked via a high-bandwidth connection, such as, for example, via a Fibre channel network, copying and other similar operations may be performed relatively rapidly. However, if the link between the two storage systems has a relatively limited bandwidth, then transmissions between the two systems may be slowed or otherwise restricted, and any copying or similar operations may likewise be slowed or inhibited.

Systems, methods, and apparatus are described herein to mitigate challenges experienced when communications are restricted by bandwidth. In accordance with one embodiment, an Internet Small Computer System Interface (iSCSI) command is used to transmit data and/or instructions via a network. iSCSI is an Internet Protocol (IP)-based storage networking standard for linking data storage facilities. iSCSI allows the transport of SCSI commands over IP networks, and is used to facilitate data transfers over intranets and to manage storage over long distances. For example, iSCSI may be used to transmit data over local area networks (LANs), wide area networks (WANs), or the Internet. In some embodiments, transmitting an iSCSI command includes transmitting a SCSI command within an IP data packet via an IP network. In other embodiments, a SCSI command may be transmitted via other types of networks, such as an infiniband network.

While certain embodiments described herein are implemented using iSCSI protocols, systems, apparatus and methods described herein may be implemented using other protocols. In various embodiments, systems, apparatus and methods described herein, or similar to those described herein, may be implemented using iSCSI or any SCSI over IP protocol, whether a standard protocol or a proprietary protocol. For example, while certain embodiments described herein require inserting a data packet into a selected field of an iSCSI command, and transmitting the iSCSI command, in other embodiments, a data packet is inserted into a selected field of a command that conforms to a different SCSI over IP protocol, and the command is transmitted.

Accordingly, in one embodiment, an instruction relating to a selected data processing operation, and information indicating that additional processing of the data packet is required, are inserted into a data packet. The data packet is inserted into a selected field of an iSCSI command, and the iSCSI command is transmitted. An iSCSI command used in such a manner is referred to herein as an enhanced iSCSI command.

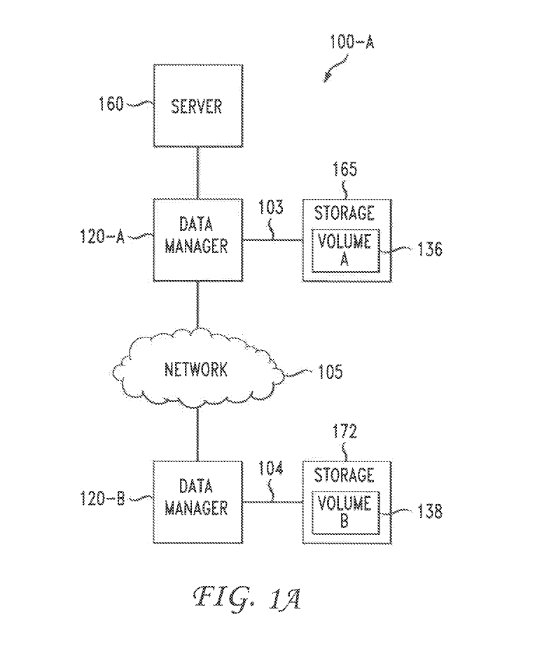

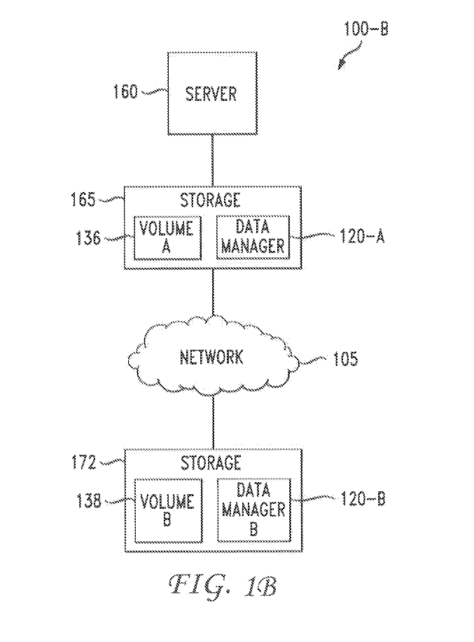

FIG. 1A shows a communication system 100-A that may be used to provide data storage and data management services in accordance with an embodiment. Communication system 100-A includes a server 160, a storage 165, a data manager 120-A, a network 105, a data manager 120-B, and a storage 172. Data manager 120-A is connected to server 160, either directly or via a network. For example, data manager 120-A may be connected to server 160 via a Fibre channel network. Data manager 120-A is connected to storage 165 via link 103, which may comprise a direct connection or a link via one or more networks. For example, data manager 120-A may be connected to storage 165 via a Fibre channel network. Data manager 120-A and data manager 120-B are connected to network 105. Thus, data manager 120-A may communicate with data manager 120-B via network 105. Storage 172 is connected to data manager 120-B via a link 104, which may comprise a direct connection or a link via one or more networks.

FIG. 1B shows a communication system in accordance with another embodiment. Communication system 100-B comprises server 160, storage 165, network 105, and storage 172. In the embodiment of FIG. 1B, data manager 120-A resides and operates on storage 165, and data manager 120-B resides and operates on storage 172.

Server 160 may be any computer or other processing device. For example, server 160 may be, without limitation, a personal computer, a laptop computer, a tablet device, a server computer, a mainframe computer, a workstation, a wireless device such as a cellular telephone, a personal digital assistant, etc. Server 160 may from time to time transmit a request to store or retrieve data, or a request for a particular data storage-related service, to storage 165. Server 160 may comprise a display device to display information to a user. Server 160 may also include a mechanism for receiving input from a user, such as a keyboard, a mouse, a touch screen, etc.

Network 105 may comprise one or more of a number of different types of networks, such as, for example, a Fibre Channel-based storage area network (SAN), an iSCSI-based network, a local area network (LAN), a wide area network (WAN), a wireless network, the Internet, etc. Other networks may be used.

In the illustrative embodiments of FIG. 1A and FIG. 1B, network 105 comprises a network having limited bandwidth, such as the Internet.

Storage 165 stores data. For example, storage 165 may store any type of data, including, without limitation, files, spreadsheets, images, audio files, source code files, etc. Storage 165 may store data in accordance with any suitable format or structure. For example, storage 165 may store data organized in volumes, blocks, files, sectors, etc. Storage 165 may store data in one or more databases or in another data structure. Storage 165 may be implemented, for example, using a storage device, a storage system, or another type of device or apparatus.

Storage 165 may from time to time receive, from another entity, a request to store specified data, and in response, store the specified data. For example, storage 165 may store data in response to a request received from server 160 or from data manager 120-A. Storage 165 may also from time to time receive, from another entity, a request for access to stored data and, in response, provide the requested data to the requesting entity, or provide access to the requested data. Storage 165 may verify that the requesting entity is authorized to access the requested data prior to providing access to the data.

Storage 172 stores data. For example, storage 172 may store any type of data, including, without limitation, files, spreadsheets, images, audio files, source code files, etc. Storage 172 may store data in accordance with any suitable format or structure. For example, storage 172 may store data organized in volumes, blocks, files, sectors, etc. Storage 172 may store data in one or more databases or in another data structure. Storage 172 may be implemented, for example, using a storage device, a storage system, or another type of device or apparatus.

Storage 172 may from time to time receive, from another entity, a request to store specified data, and in response, store the specified data. For example, storage 172 may store data in response to a request received from server 160, from data manager 120-A, or from data manager 120-B. Storage 172 may also from time to time receive, from another entity, a request for access to stored data and, in response, provide the requested data to the requesting entity, or provide access to the requested data. Storage 172 may verify that the requesting entity is authorized to access the requested data prior to providing access to the data.

Data manager 120-A performs various data storage services with respect to data stored in storage 165 and/or storage 172. In one or more embodiments, data manager 120-A may monitor data storage activities transparently. Data manager 120-A may from time to time receive from another device (e.g., server 160) a request to perform a specified data processing operation and, in response, perform the specified operation. For example, data manager 120-A may access selected data and copy the data from a first storage location to a second storage location. In the embodiment of FIG. 1A, data manager 120-A may be implemented using, for example, a server computer, a personal computer, a workstation, a mainframe computer, a tablet computer, a workstation, etc. In other embodiments, data manager 120-A may comprise software, hardware, or a combination of software and hardware.

Data manager 120-B performs various data storage services with respect to data stored in storage 165 and/or storage 172. In one or more embodiments, data manager 120-B may monitor data storage activities transparently. Data manager 120-B may from time to time receive from another device (e.g., server 160 or from data manager 120-A) a request to perform a specified data processing operation and, in response, perform the specified operation. For example, data manager 120-B may access selected data and copy the data from a first storage location to a second storage location. In the embodiment of FIG. 1A, data manager 120-B may be implemented using, for example, a server computer, a personal computer, a workstation, a mainframe computer, a tablet computer, a workstation, etc. In other embodiments, data manager 120-B may comprise software, hardware, or a combination of software and hardware.

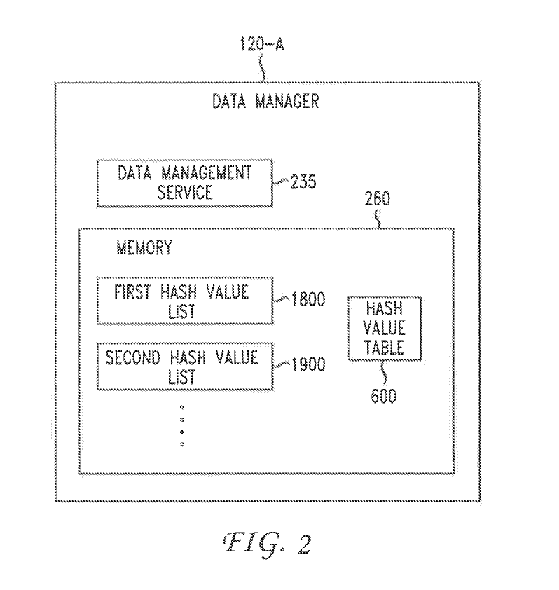

FIG. 2 shows components of data manager 120-A in accordance with the embodiment of FIG. 1A. Data manager 120-A comprises a data management service 235 and a memory 260. In other embodiments, data manager 120-A may include other components not shown in FIG. 2. Data manager 120-B may comprise components similar to the components of data manager 120-A, as shown in FIG. 2.

Data management service 235 performs one or more services and other activities relating to data storage. For example, data management service 235 may detect from server 160 a command to store specified data and, in response, perform one or more selected functions.

In the illustrative embodiment, data management service 235 performs a copy function. For example, data management service 235 may copy data from a first volume stored at a first location to a second volume stored at a second location. In other embodiments, data management service 235 may copy data organized in other formats, such as a selected block of data, a selected sector on a disk, etc., from a first location to a second location. In another embodiment, data management service 235 may copy the contents of a disk drive, tape drive, optical disk, etc., to a second storage location.

An illustrative embodiment is discussed below with reference to the embodiment of FIG. 1A; however, systems, methods, and apparatus discussed herein may be implemented using the communication system shown in FIG. 1B, or using other arrangements not shown in the Figures.

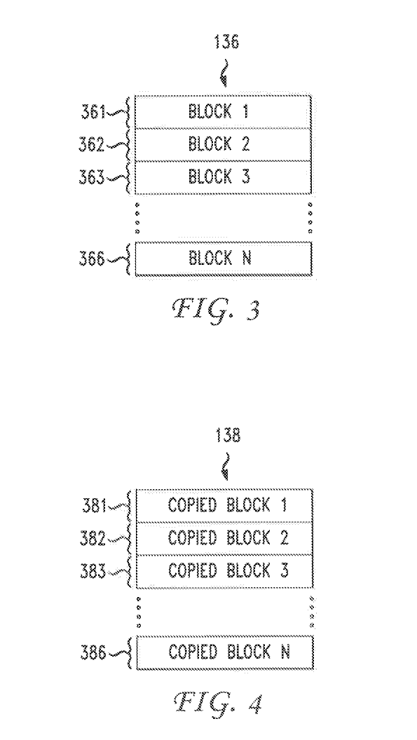

In an illustrative embodiment, data manager 120-A copies a volume 136 (stored in storage 165, as shown in FIG. 1A) from storage 165 to storage 172. Accordingly, data management service 235 accesses volume 136 and identifies a plurality of blocks within volume 136. FIG. 3 shows volume 136 in accordance with an embodiment. Volume 136 comprises a plurality of data blocks, including Block 1 (361), Block 2 (362), Block 3 (363), . . . , Block N (366). Each data block contains data.

The terms “data block” and “block” are used interchangeably herein.

Data management service 235 copies Block 1 (361) through Block N (366) and transmits the copied blocks from volume 136 to data manager 120-B. In the illustrative embodiment of FIG. 1, data manager 120-B receives the copied blocks and stores the copied blocks in a (destination) volume 138 (in storage 172). FIG. 4 shows volume 138 in accordance with an embodiment. Data manager 120-B stores a copy of Block 1 (361) in volume 138 as Copied Block 1 (381), a copy of Block 2 (362) in volume 138 as Copied Block 2 (382), a copy of Block 3 (363) in volume 138 as Copied Block 3 (383), a copy of Block N (366) in volume 138 as Copied Block N (386), etc.

In an illustrative embodiment, communications between data manager 120-A and data manager 120-B, and/or between storage 165 and storage 172, are restricted due to the limited bandwidth of network 105. Limited bandwidth can slow down transmissions and consequently increase the time and expense required to transmit data between data manager 120-A and data manager 120-B, and/or between storage 165 to storage 172.

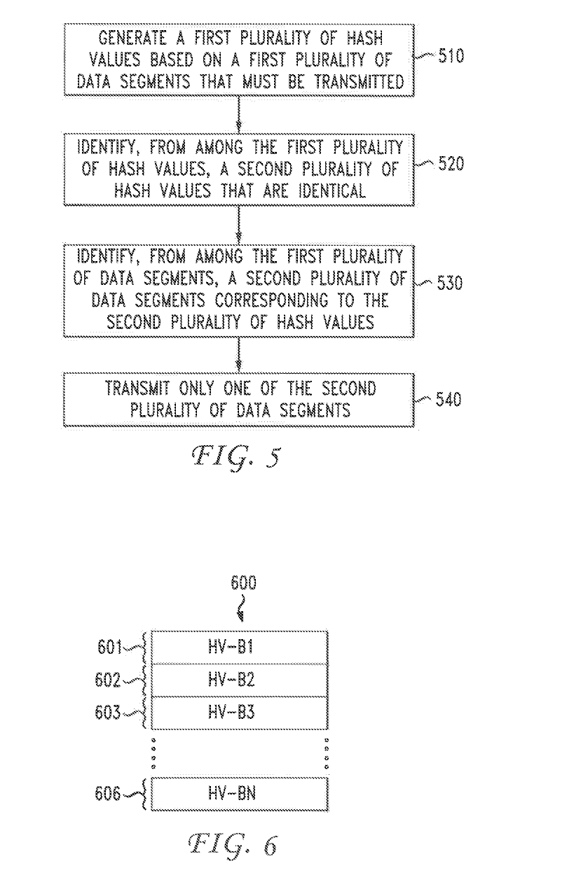

In order to mitigate problems associated with limited bandwidth, data manager 120-A copies data from volume 136 to volume 138 using a deduplication technique. Deduplication is a technique for eliminating duplicate copies of repeating data. FIG. 5 is a flowchart of a method of copying data using deduplication in accordance with an embodiment. At step 510, a first plurality of hash values is generated based on a first plurality of data segments that must be transmitted. Data manager 120-A generates, for each data block in volume 136, a hash value. Data manager 120-A may store the hash values in a hash value table such as hash value table 600 shown in FIG. 6. Hash value table 600 comprises a plurality of hash values including a hash value HV-B1 (601), which corresponds to Block 1 (361), a hash value HV-B2 (602), which corresponds to Block 2 (362), a hash value HV-B3 (603), which corresponds to Block 3 (363), a hash value HV-BN (606), which corresponds to Block N (366), etc. Hash value table 600 may be stored in memory 260 (of data manager 120-A), as shown in FIG. 2.

Returning to FIG. 5, at step 520, a second plurality of hash values that are identical is identified from among the first plurality of hash values. Data manager 120-A examines the hash values in hash value table 600 and determines if two or more of the hash values are identical. If two hash values are identical, data manager 120-A concludes that the corresponding data blocks are identical. Data manager 120-A consequently determines that it is sufficient to transmit only one of the corresponding data blocks to storage 172 with instructions to deduplicate the data block (i.e., store the data block in multiple locations as appropriate).

In the illustrative embodiment, data manager 120-A determines that hash value HV-B1 (601) and HV-B3 (603) are identical. At step 530, a second plurality of data segments corresponding to the second plurality of hash values is identified from among the first plurality of data segments. Data manager 120-A determines that hash value HV-B1 (601) corresponds to Block 1 (361) and that hash value HV-B3 (603) corresponds to Block 3 (363). Data manager 120-A further concludes that the Block 1 (361) and Block 3 (363) are identical, and that it is sufficient to transmit only one of the data blocks to data manager 120-B (or to storage 172).

At step 540, only one of the second plurality of data segments is transmitted. In the illustrative embodiment of FIG. 1A, data manager 120-A transmits only Block 1 (361) to data manager 120-B, and a first instruction to write Block 1 (361) to a selected location. Data manager 120-A does not transmit Block 3 (363) to data manager 120-B.

Data manager 120-A also transmits to data manager 120-B an instruction to deduplicate Data Block 1 (361). Specifically, data manager 120-A transmits a second instruction to store a copy of Block 1 (361), or a reference to Block 1 (361), at a location in volume 138 corresponding to Block 3 (363).

Data manager 120-B receives Block 1 (361) and the first instruction, and, based on the first instruction, stores Block 1 (361) at a location within volume 138 corresponding to Block 1 (361). Based on the second instruction, data manager 120-B stores a copy of Block 1 (361) (or a reference thereto) at a location within volume 138 corresponding to Block 3 (363). Data manager 120-A may continue copying (and transmitting to data manager 120-B) other blocks within volume 136.

In order to further mitigate problems associated with limited bandwidth, data manager 120-A transmits data and instructions to data manager 120-B using an enhanced iSCSI command.

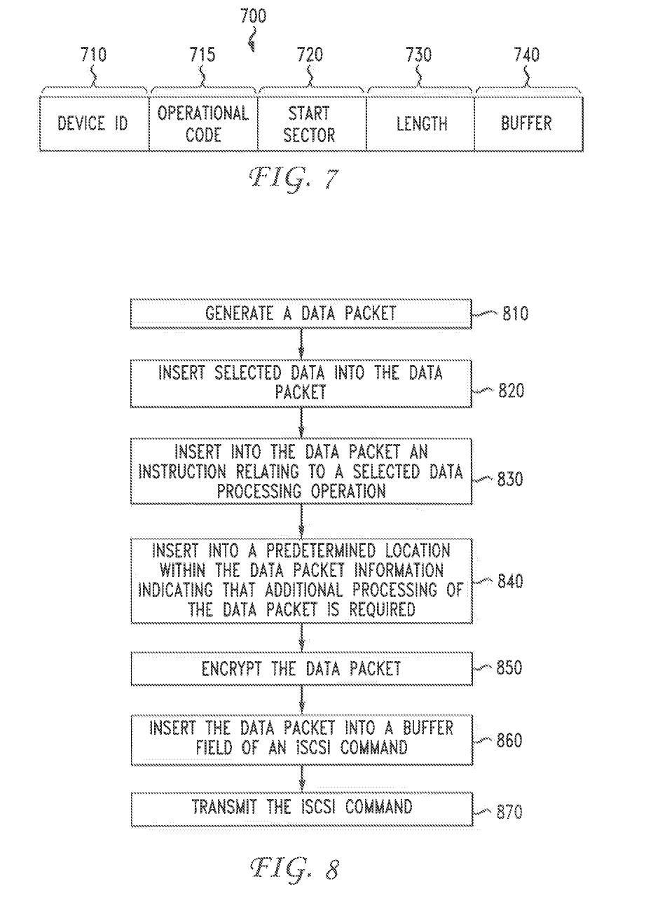

FIG. 7 shows an exemplary iSCSI command. In accordance with iSCSI protocols, iSCSI command 700 comprises a device identifier field 710, an operational code field 715, a start sector field 720, a length field 730, and a buffer field 740.

In one embodiment, data manager 120-A uses an enhanced iSCSI command to transmit data to data manager 120-B via network 105. For example, referring to the illustrative embodiment described above, data manager 120-A may use an enhanced iSCSI command to transmit Block 1 (361) and an associated instruction to data manager 120-B.

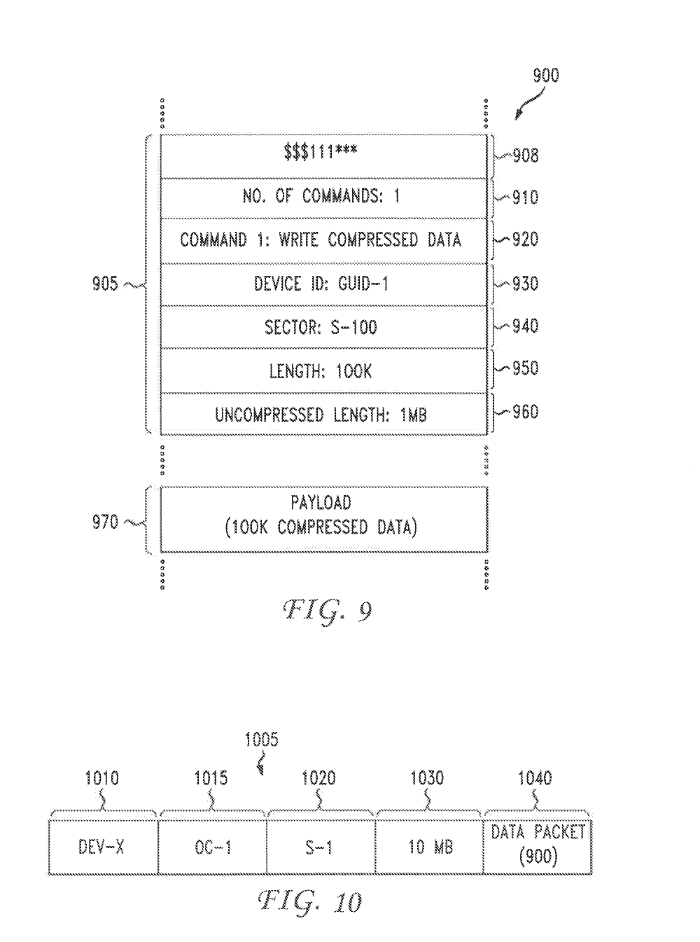

FIG. 8 is a flowchart of a method of transmitting data and/or instructions in accordance with an embodiment. At step 810, a data packet is generated. Data management service 235 generates a data packet such as that shown in FIG. 9. Data packet 900 comprises a first segment 905 and a second segment 970. For convenience, first segment 905 is referred to herein as header segment 905, and second segment 970 is referred to herein as payload segment 970.

At step 820, selected data is inserted into the data packet. In the illustrative embodiment, data manager 120-A inserts Block 1 (361) into data packet 900. Data manager 120-A compresses Block 1 (361) before transmitting the block. The compression operation generates a compressed version of Block 1 (361) that includes 100 k of compressed data. Data management service 235 inserts compressed Block 1 (361) into payload segment 970 of data packet 900. Therefore, payload segment 970 includes 100 k of compressed data, as indicated in FIG. 9.

At step 830, an instruction relating to a selected data processing operation is inserted into the data packet. Referring to FIG. 9, data management service 235 inserts an instruction and other selected information into header segment 905. Specifically, data management service 235 inserts, in a command quantity field 910, information specifying a quantity of commands or instructions that are included in data packet 900. Any number of instructions, and any type of instructions, may be included in a data packet. In the illustrative embodiment, data management service 235 inserts into command quantity field 910 information indicating that data packet 900 holds one (1) instruction. “Command 1” field 920 includes an instruction; specifically, data management service 235 inserts into field 920 an instruction (represented in FIG. 9 as “Write Compressed Data”) to decompress the specified data stored in the payload segment and to write the decompressed data at a specified location. In a device identifier field 930, data management service 235 specifies an identifier of storage 172. Any type of identifier may be used to identify a storage device or system. In the illustrative example, data management service 235 inserts into field 930 a global unique identifier associated with storage 172 (represented in FIG. 9 as “GUID-1”). In a start sector field 940, data management service 235 identifies a sector where Block 1 (361) is to be written. In the illustrative example, data management service 235 specifies a sector by an identifier represented in FIG. 9 as “S-100.” In other embodiments, sectors (and other storage locations) may be identified using other types of identifiers or other techniques. Data management service 235 specifies the length (100 k) of the compressed data stored in the payload in a length field 950, and the uncompressed length (1 MB) of Block 1 (361) in an uncompressed length field 960.

FIG. 9 is illustrative and is not to be construed as limiting. For example, data packet 900 may comprise other segments, and other types of information, not shown in FIG. 9. In addition, header segment 905 and/or payload segment 970 of data packet 900 may comprise other fields, and other types of information not shown in FIG. 9.

At step 840, information indicating that additional processing of the data packet is required is inserted at a predetermined location within the data packet. For example, a flag or other type of indicator, such as a predetermined bit, or a predetermined sequence of bits, may be inserted into a field of header segment 905. The predetermined bit or sequence of bits may function as a flag, or instruction, to a receiving device to examine the data packet for one or more data processing instructions. In one embodiment, the predetermined sequence of bits comprises a sequence of bits that has a very low probability of appearing randomly. In the illustrative embodiment of FIG. 10A, data management service 235 inserts the predetermined sequence “$$$111***” into an indicator field 908 of data packet 900. The sequence of bits shown in FIG. 9 is illustrative; other sequences of bits may be used.

At step 850, the data packet is encrypted. Data management service 235 encrypts data packet 900 using a selected encryption algorithm. Any one of a number of known encryption techniques may be used. Alternatively, a proprietary encryption technique may be used.

Encryption is optional. In other embodiments, data packet 900 is not encrypted.

At step 860, the data packet is inserted into a buffer field of an iSCSI command. Data management service 235 generates an iSCSI command (similar to command 700 of FIG. 7) and inserts (encrypted) data packet 900 into the buffer field of the command. FIG. 10 shows an iSCSI command in accordance with an embodiment. iSCSI command 1005 comprises a device identifier field 1010 (comprising a device identifier “DEV-X”), an operational command field 1015 (comprising operational command data “OC-1”), a start sector field 1020 (comprising start sector data “S-1”), a length field 1030 (indicating a length of 10 MB), and a buffer field 1040. In the illustrative embodiment, data management service 235 inserts encrypted data packet 900 into buffer field 1040.

At step 870, the iSCSI command is transmitted. Data management service 235 now transmits iSCSI command 1005 via network 105 to data manager 120-B. For example, iSCSI command 1005 may be transmitted within an IP data packet.

In accordance with another embodiment, data manager 120-B receives the iSCSI command carrying data packet 900 and determines that additional processing of the data packet is necessary. In response, data manager 120-B extracts data packet 900, examines the information in header segment 905 for an instruction, and performs additional processing in accordance with the instruction.

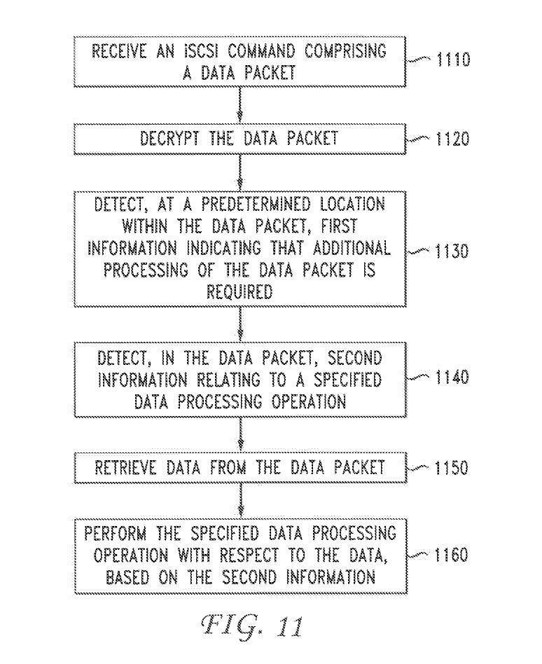

FIG. 11 is a flowchart of a method of managing data in accordance with an embodiment. At step 1110, an iSCSI command comprising a data packet is received. In the illustrative embodiment, data manager 120-B receives iSCSI command 1005, and determines that the command comprises (encrypted) data packet 900, in buffer field 1040.

At step 1120, the data packet is decrypted. Accordingly, data manager 120-B retrieves encrypted data packet 900 and decrypts the data packet.

At step 1130, first information indicating that additional processing of the data packet is required is detected at a predetermined location within the data packet. In the illustrative embodiment, data manager 120-B examines data packet 900 and detects the predetermined sequence of bits “$$$111***” in field 908. In response to detecting the predetermined sequence of bits, data manager 120-B determines that data packet 900 requires additional processing.

At step 1140, second information relating to a specified data processing operation is detected in the data packet. Data manager 120-B now examines header segment 905 of data packet 900. Data manager 120-B determines from field 910 that the data packet comprises one instruction. Data manager 120-B identifies in field 920 the “Write Compressed Data” instruction. Data manager 120-B also examines fields 930, 940, 950, and 960 and determines that the relevant device identifier is GUID-1, the start sector is S-100, the compressed length of the data is 100 k, and the uncompressed length of the data is 1 MB.

At step 1150, data is retrieved from the data packet. Accordingly, data manager 120-B retrieves (compressed) Block 1 (361) from payload segment 970. At step 1160, the specified data processing operation is performed with respect to the data, based on the second information. In accordance with the “Write Compressed Data” instruction, data manager 120-B decompresses Block 1 (361) and then writes the data block at sector S-100.

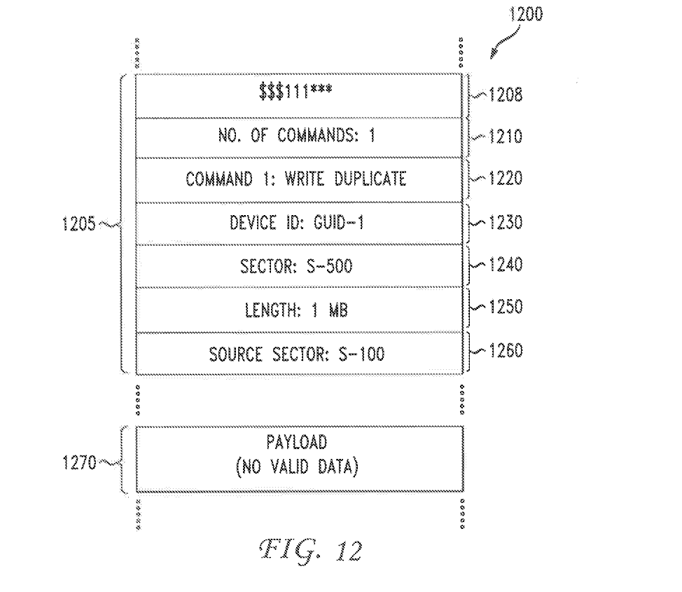

In one embodiment, after data manager 120-A transmits Block 1 (361), data manager 120-A transmits another command including an instruction to deduplicate the data in Block 1 (361) to a storage location corresponding to Block 3 (363). For example, data manager 120-A may generate and transmit a second enhanced iSCSI command containing a data packet such as that shown in FIG. 12.

FIG. 12 shows a data packet in accordance with an embodiment. Data packet 1200 includes a header segment 1205 and a payload segment 1270. Header segment 1205 includes an indicator field 1208 that stores the predetermined sequence of bits “$$$111***” indicating that the data packet requires additional processing. Header segment 1205 also includes an instruction and other selected information. Specifically, a command quantity field 1210 indicates that packet 1200 holds one (1) instruction. “Command 1” field 1220 holds a “Write Duplicate” instruction indicating that specified data is to be deduplicated. A device ID field 1230 includes an identifier of storage 172 (“GUID-1”). A start sector field 1240 indicates that data is to be written to a sector identified as sector “S-500.” A length field 1250 indicates the length of the data (1 MB). A source sector field 1260 specifies a sector (identified as sector “S-100”) from which data is to be deduplicated. Payload segment 1270 does not contain any valid data.

In the illustrative embodiment, data management service 235 encrypts data packet 1200, and generates an iSCSI command similar to command 1005 of FIG. 10. Data management service 235 inserts data packet 1200 into the buffer field of the iSCSI command, and then transmits the iSCSI command 1200 to data manager 120-B.

When data manager 120-B receives iSCSI command 1200, data manager 120-B examines data packet 1200 and detects the predetermined sequence of bits in indicator field 1208. In response to detecting the predetermined sequence of bits, data manager 120-B determines that the data packet requires additional processing. Data manager 120-B accordingly examines the information in header segment 1205. Data manager 120-B determines that data packet 1200 contains a “Write Duplicate” instruction indicating that specified data should be deduplicated. Data manager 120-B determines, based on fields 1240, 1250 and 1260, that 1 MB of data starting at sector S-100 is to be copied to sector S-500. Data manager 120-B accordingly copies the specified quantity of data from sector S-100 to S-500. In another embodiment, data manager 120-B stores, at sector S-500, a reference or pointer to source sector S-100).

Enhanced iSCSI commands may thus be used advantageously by data manager 120-A and data manager 120-B to copy data from volume 136 to volume 138, and to decompress and deduplicate the data, in an efficient manner, such that data transmission requirements are minimized.

### Other Implementations

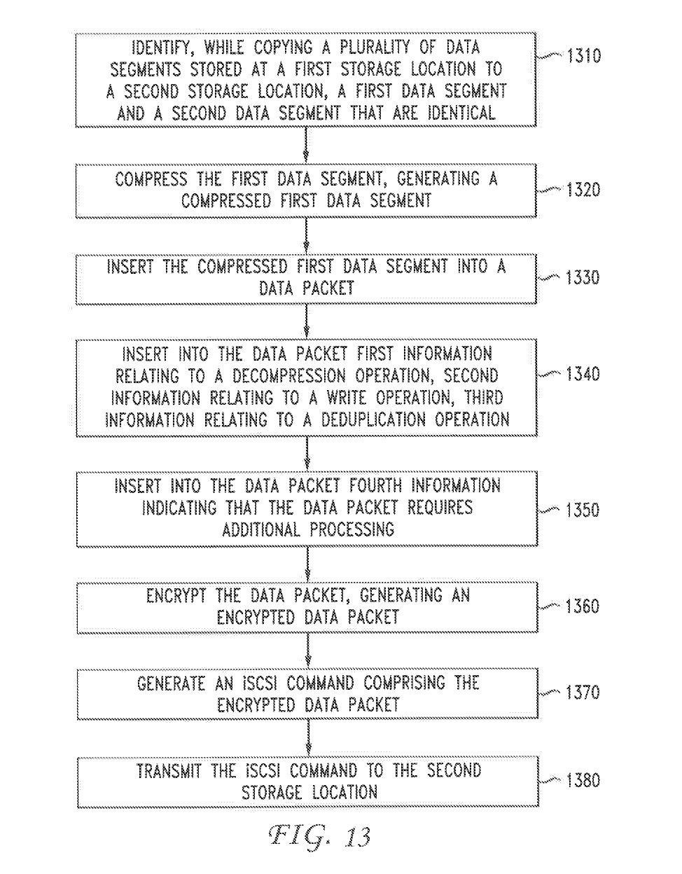

In accordance with another embodiment, an enhanced iSCSI command may be used to transmit a plurality of instructions relating to one or more data processing operations. For example, the two instructions carried in data packet 900 (of FIG. 9) and packet 1200 (of FIG. 12) may be transmitted via a single data packet within a single iSCSI command. A method for transmitting a plurality of instructions is described below with reference to FIG. 13.

FIG. 13 is a flowchart of a method of using an iSCSI command to manage data in accordance with another embodiment. The steps outlined in FIG. 13 are discussed using a scenario similar to that described in the illustrative embodiment described above.

At step 1310, a first data segment and a second data segment that are identical are identified, while copying a plurality of data segments stored at a first storage location to a second storage location. In the manner described above, data manager 120-A, while copying volume 136 from storage 165 to storage 172, determines that Block 1 (361) and Block 3 (363) are identical.

At step 1320, the first data segment is compressed, generating a compressed first data segment. Data manager 120-A retrieves Block 1 (361) and compresses the data block.

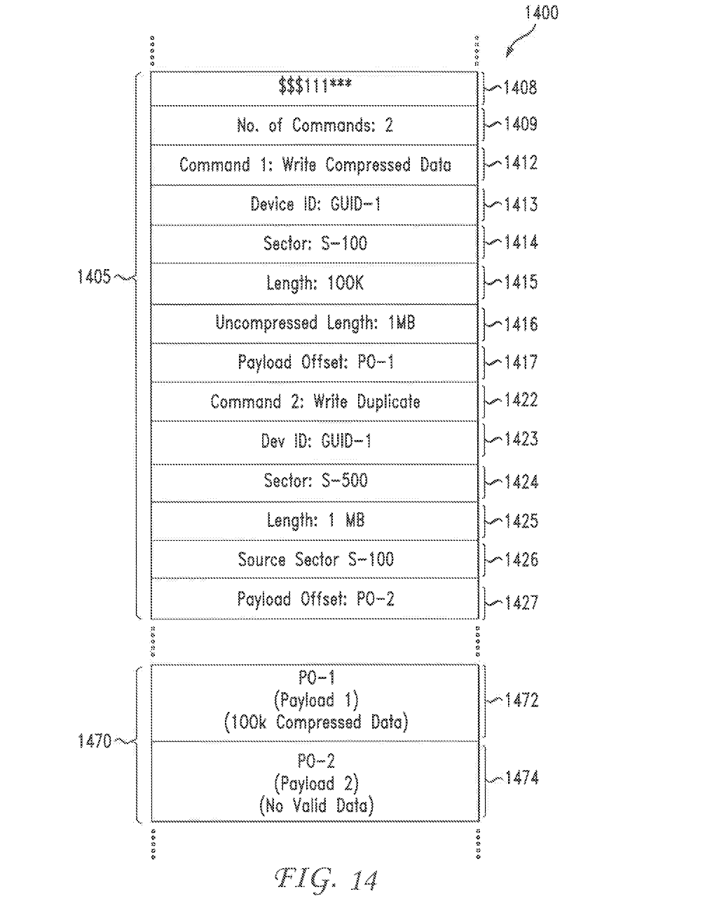

At step 1330, the compressed first data segment is inserted into a data packet. Data manager 120-A generates a data packet such as that shown in FIG. 14. Data packet 1400 comprises a header segment 1405 and a payload segment 1470.

In the illustrative embodiment, payload segment 1470 includes a first payload section 1472 (referred to in FIG. 14 as “Payload 1”), located at payload offset PO-1, and a second payload section 1474 (referred to in FIG. 14 as “Payload 2”), located at payload offset PO-2. Data manager 120-A inserts the compressed version of Block 1 (361) into first payload section 1472.

At step 1340, first information relating to a decompression operation, second information relating to a write operation, and third information relating to a deduplication operation are inserted into the data packet. Data manager 120-A inserts into a command quantity field 1409 information indicating a quantity of instructions that are included in data packet 1400. In this instance, data manager 120-A inserts “2” into field 1409, indicating that data packet 1400 holds two instructions. Data manager 120-A now inserts specific instructions and information into header segment 1405 as shown in FIG. 14. Field 1412 holds a first instruction (“Write Compressed Data”) relating to decompression and writing of the data block, and fields 1413-1417 hold information relating to the first instruction. Specifically, field 1413 holds an identifier of the destination device (storage 172); field 1414 indicates a start sector where data is to be written; field 1415 indicates a length of the compressed data stored in the payload of the data packet; field 1416 indicates a length of the uncompressed data to be written; and field 1417 stores a payload offset indicating a location within payload segment 1470 where the data associated with the first instruction is stored. In the illustrative embodiment, payload offset field 1417 holds information identifying the location of first payload section 1472 (represented in FIG. 14 as “PO-1”).

Field 1422 holds a second instruction (“Write Duplicate”) relating to deduplication. Fields 1423-1427 include information relating to the second instruction. Specifically, field 1423 holds a device identifier associated with storage 172; field 1424 holds information identifying a start sector to which data is to be deduplicated; field 1425 indicates a length of the data to be duplicated; field 1426 indicates a source sector from which data is to be deduplicated; and field 1427 stores a payload offset indicating a location in payload segment 1470 where data associated with the second instruction is stored. In the present instance, payload offset field 1427 stores information identifying the location of second payload section 1474, represented in FIG. 14 as “PO-2.” In the illustrative embodiment of FIG. 14, second payload section 1474 contains no valid data.

At step 1350, fourth information indicating that the data packet requires additional processing is inserted into the data packet. In a manner similar to that described above, data manager 120-A inserts, into an indicator field 1408 within header segment 1405, the predetermined sequence “$$$111***.”

At step 1360, the data packet is encrypted, generating an encrypted data packet. Data manager 120-A uses a selected encryption algorithm to encrypt data packet 1400. At step 1370, an iSCSI command comprising the data packet is generated. Data manager 120-A generates an iSCSI command in the manner described above. Data packet 1400 is inserted into the buffer segment of the iSCSI command. At step 1380, the iSCSI command is transmitted to the second storage location. In the illustrative embodiment, data manager 120-A transmits the iSCSI command to data manager 120-B.

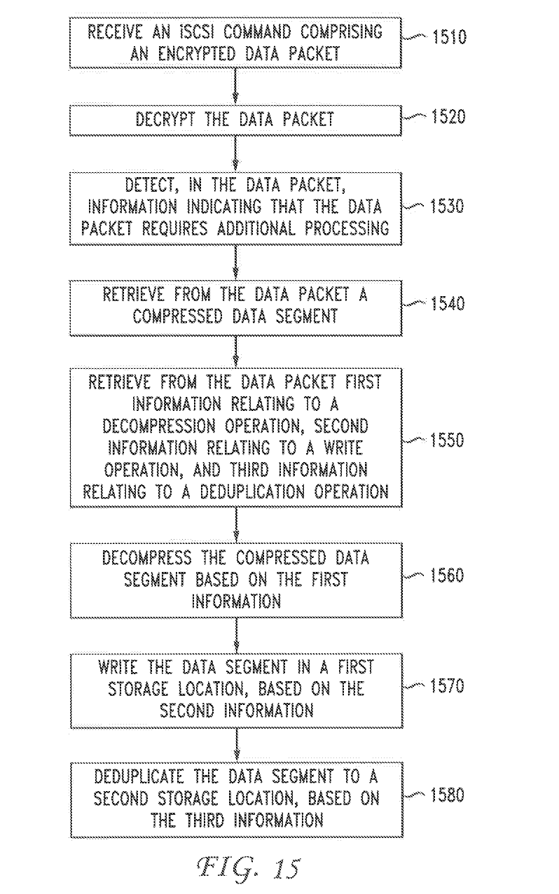

Data manager 120-B receives the iSCSI command and processes it accordingly. FIG. 15 is a flowchart of a method of managing data in accordance with an embodiment. At step 1510, an iSCSI command comprising an encrypted data packet is received. At step 1520, the data packet is decrypted. Data manager 120-B receives the iSCSI command, decrypts the command, and examines data packet 1400.

At step 1530, information indicating that the data packet requires additional processing instruction is detected in the data packet. Data manager 120-B determines that data packet 1400 contains the predetermined sequence “$$$111***” in field 1408.

At step 1540, a compressed data segment is retrieved from the data packet. Data manager 120-B retrieves compressed Block 1 (361) from first payload section 1472 of data packet 1400. At step 1550, first information relating to a decompression operation, second information relating to a write operation, and third information relating to a deduplication operation are retrieved from the data packet. Data manager 120-B examines field 1401 and determines that data packet 1400 includes two instructions. Data manager 120-B examines the first instruction (Write Compressed Data”) stored in field 1412. Data manager 120-B also examines fields 1413-1417 to obtain additional information relating to decompression and writing of Block 1 (361). In the illustrative embodiment, data manager 120-B determines, based on the first instruction, that the data stored at payload offset PO-1 is to be decompressed and written to sector S-100. Data manager 120-B also examines field 1422, which holds a second instruction (“Write Duplicate”), and fields 1423-1427, which include information related to deduplication. Specifically, data manager 120-B determines, based on the second instruction, that data starting at source sector S-100 is to be deduplicated to sector S-500.

At step 1560, the compressed data segment is decompressed based on the first information, generating a decompressed data segment. Data manager 120-B accordingly decompresses the compressed version of Block 1 (361), obtaining a decompressed version of Block 1 (361). At step 1570, the data segment is written in a first storage location, based on the second information. Based on the second instruction and the information in fields 1413-1417, data manager 120-B writes Block 1 (361) at sector S-100 within volume 138.

At step 1580, the data segment is deduplicated to a second storage location based on the third information. Based on the second instruction and the information fields 1413-1417, data manager 120-B deduplicates Block 1 (361) from sector S-100 to sector S-500.

The systems, methods, and apparatus described above may be used to perform a variety of different data management operations. For example, the systems, methods and apparatus described herein may be used to perform, without limitation, a copy operation, a compression operation, a decompression operation, a deduplication operation, a backup operation, a replication operation, a migration operation, a synchronization operation, a snapshot operation, etc.

Suppose, for example, that after volume 136 is copied to volume 138, one or more blocks in volume 136 are edited or otherwise changed. Suppose further that data manager 120-A subsequently determines that it is necessary to synchronize volume 136 and volume 138. In order to synchronize volume 136 and volume 138, data manager 120-A may use one or more iSCSI commands to transmit all or a portion of the data in volume 136 to data manager 120-B and/or to storage 172. An illustrative embodiment in which iSCSI commands are used to perform a synchronization operation is described below.

Suppose that after volume 136 is copied to volume 138, a change is made to Block 2A (362A) of volume 136. As a result, volume 136 now contains an Updated Block 2A (362A), as shown in FIG. 16.

In accordance with an embodiment, instead of copying volume 136 in its entirety to data manager 120-B and/or to storage 172, data manager 120-A may reduce data transmission requirements by transmitting only one or more selected portions of volume 136, and one or more instructions to deduplicate the one or more selected portions to multiple locations within volume 138.

In one embodiment, data management service 235 (of data manager 120-A) generates a plurality of first hash values representing the respective data blocks of volume 136, in a manner similar to that described above. Data manager 120-A instructs data manager 120-B to generate a plurality of second hash values representing respective data blocks of volume 138. In response, data manager 120-B generates a plurality of second hash values representing the data blocks of volume 138, and transmits the plurality of second hash values to data manager 120-A.

Data manager 120-A receives the plurality of second hash values and compares the second hash values to the first hash values to identify any differences between volume 136 and volume 138. In the illustrative embodiment, data manager 120-A compares the first hash values to the corresponding second hash values and determines, based on the comparison, that the first hash value associated with Updated Block 2A (362A) of volume 136 is not the same as the second hash value associated with Copied Block 2 (382) of volume 138. Data manager 120-A therefore concludes that Updated Block 2A (362A) has been changed since volume 136 was copied to volume 138. Data manager 120-A may use this method to identify other data blocks within volume 136 that have been changed.

Supposing that other data blocks have been changed since volume 136 was copied to volume 138, data manager 120-A may employ deduplication techniques to reduce data transmission requirements. Thus, for example, data manager 120-A may examine the first hash values representing the data blocks of volume 136 that have been changed, to determine if any of those hash values are identical to the hash value associated with Updated Block 2A (362A). If any of the hash values are identical to the hash value associated with Updated Block 2A (362A), then data manager 120-A concludes that the corresponding data blocks are identical to Updated Block 2A (362A). In such event, data manager 120-A concludes that only one copy of Updated Block 2A (362A) need be transmitted. Data manager 120-A accordingly transmits to data manager 120-B a single copy of Updated Block 2A (362A), and instructions to store the data block in a location corresponding to Updated Block 2A (362A) and to deduplicate the block to any other appropriate locations in volume 138.

Data management service 235 uses an iSCSI command to transmit Updated Block 2A (362A) to data manager 120-B. In an illustrative embodiment, data management service 235 compresses Updated Block 2A (362A), and inserts the compressed data block into a data packet. Data management service 235 inserts into the header segment of the data packet one or more instructions to decompress the compressed data block, to write the decompressed copy of Updated Block 2A (362A) at a specified location within volume 138, and, if appropriate, to deduplicate the data block to other specified locations within volume 138. Data management service 235 may also insert into the header segment additional related information.

Data management service 235 inserts, into a field within the data packet, information (such as a predetermined sequence of bits) indicating that the data packet requires additional processing. The data packet may be encrypted. The data packet is inserted into an iSCSI command. Data management service 235 transmits the iSCSI command to data manager 120-B (or to storage 172).

Data manager 120-B receives the iSCSI command and detects the predetermined sequence of bits within the data packet. In response to detecting the predetermined information within the iSCSI command, data manager 120-B extracts the data packet from the command, decrypts the data packet as necessary, and retrieves the compressed data block from the data packet. Data manager 120-B examines the instructions (to decompress, write, etc.), and the related information, and in response decompresses the data block. Data manager 120-B then writes the copy of Updated Data Block 2A (362A) at the specified location in volume 138. Data manager 120-B may also deduplicate the data block to other locations in volume 138, in accordance with the instructions.

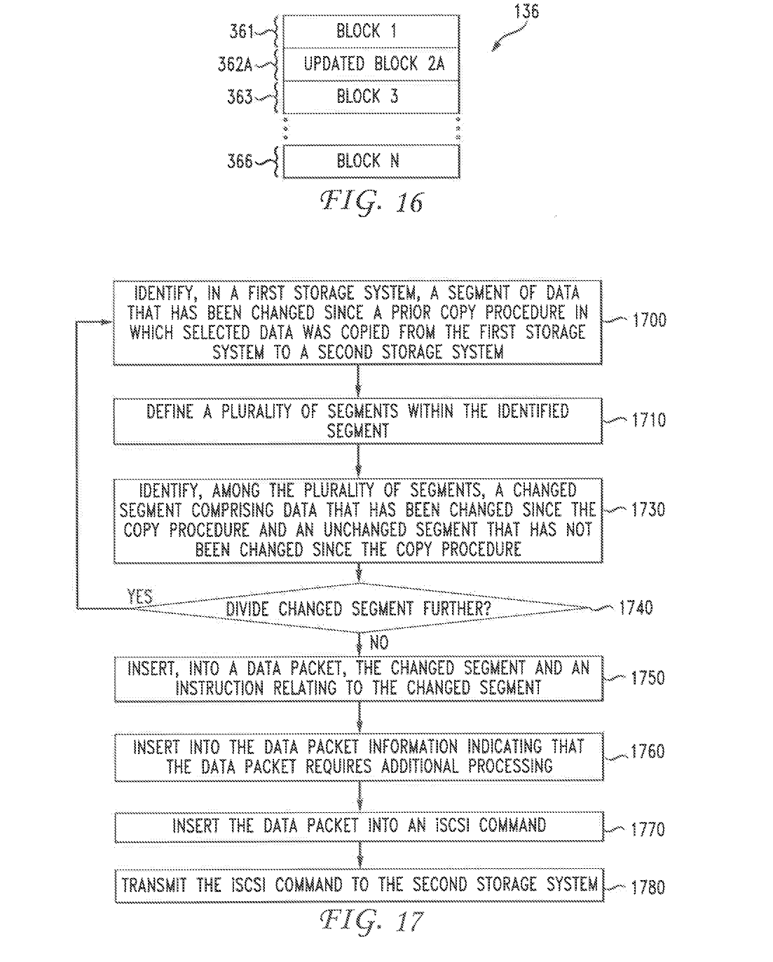

In one embodiment, further reductions of transmission requirements may be achieved by analyzing a changed data block at further levels of granularity. Such an analysis allows data manager 120-A to avoid the need to transmit an entire data block (such as Updated Block 2A (362)), and instead to transmit only one or more portions of the data block. FIG. 17 is a flowchart of a method of managing data in accordance with an embodiment. At step 1700, a segment of data that has been changed since a prior copy procedure in which selected data was copied from a first storage system to a second storage system is identified in the first storage system. In the manner described above, data management service 235 (of data manager 120-A) identifies Updated Block 2A (362A) as a block that has been changed since volume 136 was copied to volume 138.

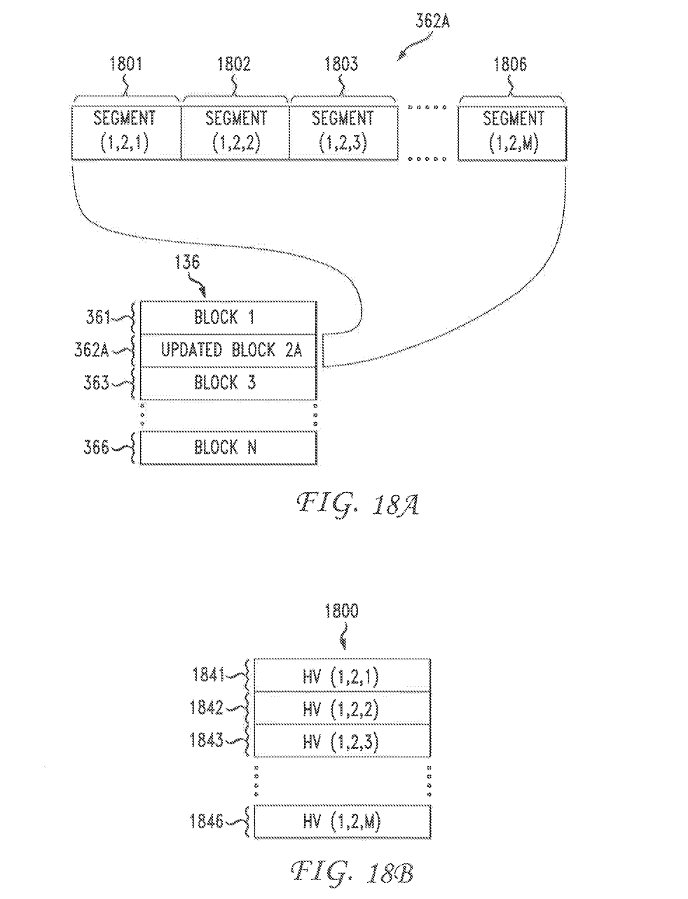

At step 1710, a plurality of segments is defined within the identified segment. Data management service 235 accesses Updated Block 2A (362A) and defines a plurality of first segments within the block. FIG. 18A shows a plurality of first segments defined within Updated Block 2A (362A) in accordance with an embodiment. Specifically, data management service 235 defines a plurality of first segments including a first segment (1, 2, 1) (1801), a first segment (1, 2, 2) (1802), a first segment (1, 2, 3) (1803), . . . , a first segment (1, 2, M) (1806), etc.

In this discussion, the term “first segment” is used to signify a segment stored in storage 165; the term “second segment” is used to signify a segment stored in storage 172. Also, in this discussion, a respective segment is identified by an array of elements which define its location. Specifically, the array includes a first element that identifies a volume (‘1’ for volume 136, ‘2’ for volume 138), a second element that identifies a block within the volume, a third element that identifies a segment within the block, and may include additional elements, if necessary, to identify a location of a segment with additional degrees of granularity within a previously identified segment. Thus, segment (1, 2, 1) identifies volume 136, block 2, segment 1. Segment (2, 2, 1) identifies volume 138, block 2, segment 1. Other methods of identifying segments may be used.

At step 1730, a changed segment comprising data that has been changed since the copy procedure, and an unchanged segment that has not been changed since the copy procedure, are identified among the plurality of segments. In the illustrative embodiment, data management service 235 uses hash values to identify which segments, if any, have been changed. Specifically, data management service 235 uses a hash function to generate a respective first hash value representing each first segment defined within Updated Block 2A (362A). For example, data management service 235 may generate respective first hash values based on first segment (1, 2, 1) (1801), first segment (1, 2, 2) (1802), etc. Data management service 235 stores the resulting first hash values in a first hash value list such as that shown in FIG. 18B. Thus, first hash value list 1800) includes a first hash value HV (1, 2, 1) (1841), which corresponds to first segment (1, 2, 1) (1801), a first hash value HV (1, 2, 2) (1842), which corresponds to first segment (1, 2, 2) (1802), a first hash value HV (1, 2, 3) (1843), which corresponds to first segment (1, 2, 3) (1803), a first hash value HV (1, 2, M) (1846), which corresponds to first segment (1, 2, M) (1806), etc. First hash value list 1800 is stored in memory 260 of data manager 120-A, as shown in FIG. 2.

In other embodiments, other types of digests may be used, and other methods may be used to generate digests. For example, a cyclic redundancy check may be used.

Data management service 235 now instructs data manager 120-B to define corresponding segments within Copied Block 2 (382) of volume 138, and to generate hash values based on the segments. Data management service 235 may inform data manager 120-B of the hash function used to generate hash values 1841, 1842, etc.

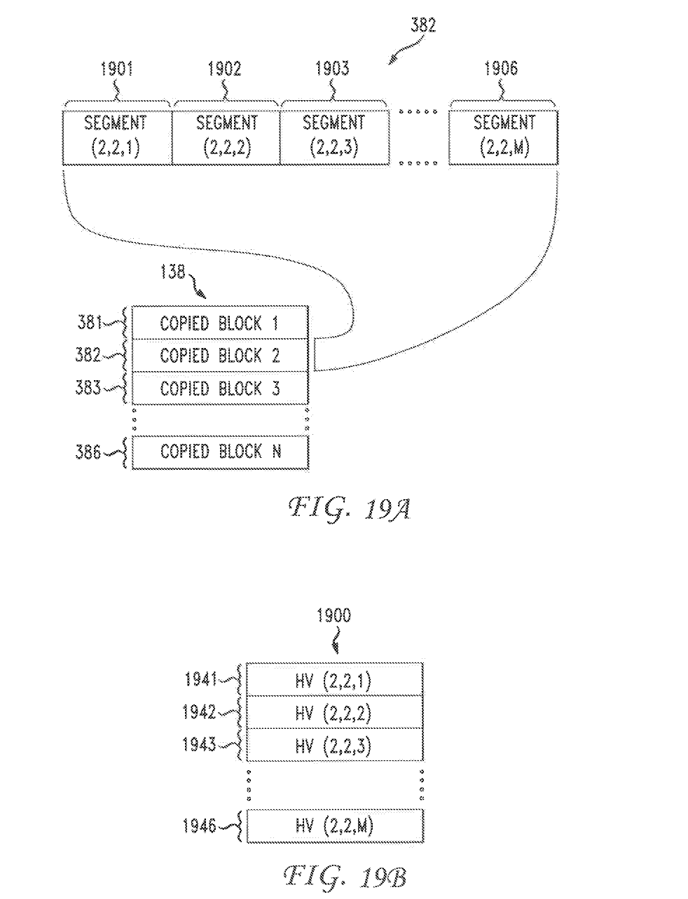

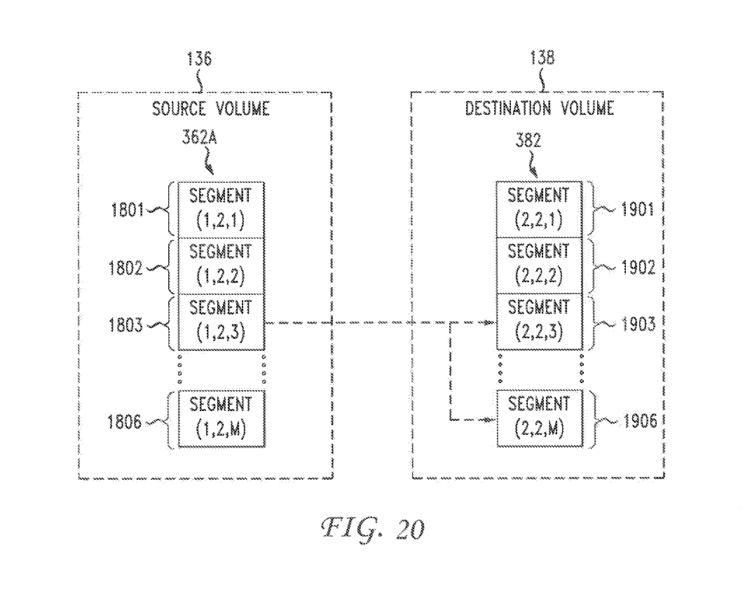

Data manager 120-B, in response, accesses Copied Block 2 (382) of volume 138, and defines a plurality of second segments within the block. FIG. 19A shows a plurality of second segments defined within Copied Block 2 (382) in accordance with an embodiment. Specifically, data manager 120-B defines a plurality of segments including a second segment (2, 2, 1) (1901), a second segment (2, 2, 2) (1902), a second segment (2, 2, 3) (1903), . . . , a second segment (2, 2, M) (1906), etc. Data manager 120-B now uses the hash function to generate a second hash value based on each respective second segment defined within Copied Block 2 (382), and transmits the second hash values to data manager 120-A.

Data management service 235 receives the second hash values from data manager 120-B, and stores the second hash values in a second hash value list such as that shown in FIG. 19B. Thus, second hash value list 1900 includes a second hash value HV (2, 2, 1) (1941), which corresponds to second segment (2, 2, 1) (1901), a second hash value HV (2, 2, 2) (1942), which corresponds to second segment (2, 2, 2) (1902), a second hash value HV (2, 2, 3) (1943), which corresponds to second segment (2, 2, 3) (1903), and a second hash value HV (2, 2, M) (1946), which corresponds to second segment (2, 2, M) (1906). Second hash value list 1900 is stored in memory 260 of data manager 120-A, as shown in FIG. 2.

Data management service 235 accesses first hash value list 1800 and, for each first hash value stored therein, compares the first hash value to a corresponding second hash value stored in second hash value list 1900. Thus, for example, data management service 235 compares first hash value HV (1, 2, 1) (1841) to second hash value HV (2, 2, 1) (1941). If the first hash value and the second hash value are the same, data management service 235 concludes that the corresponding first segment (1, 2, 1) (1801) of Updated Block 2A (362A) is the same as second segment (2, 2, 1) (1901) of Copied Block 2 (382), and that therefore there is no need to copy first segment (1, 2, 1) (1801) to storage 172. If the first hash value and the second hash value are not the same, data management service 235 concludes that first segment (1, 2, 1) (1801) of Updated Block 2A (362A) is not the same as second segment (2, 2, 1) (1901) of Copied Block 2 (382), and consequently concludes that first segment (1, 2, 1) (1801) has been changed. Data management service 235 thus determines that it is necessary to copy first segment (1, 2, 1) (1801) to volume 138.

Data management service 235 similarly compares other first hash values to corresponding second hash values. Thus data management service 235 compares first hash value HV (1, 2, 2) (1842) to second hash value HV (2, 2, 2) (1942), first hash value HV (1, 2, 3) (1843) to second hash value HV (2, 2, 3) (1943), first hash value HV (1, 2, M) (1846) to second hash value HV (2, 2, M) (1946), etc. For each first hash value-second hash value pair, if the first hash value and the corresponding second hash value are the same, data management service 235 concludes that the corresponding segments are the same and that it is therefore not necessary to copy the corresponding first segment of Updated Block 2A (362A) to data manager 120-B and/or to storage 172. If the first hash value and the corresponding second hash value are not the same, data management service 235 concludes that the corresponding segments are not the same, and that the corresponding first segment of Updated Block 2A (362A) has been changed. Data management service 235 therefore determines that it is necessary to copy the corresponding first segment of Updated Block 2A (362A) to data manager 120-B and/or to storage 172.

Supposing that, in the illustrative embodiment, data management service 235 determines that first hash value HV (1, 2, 1) (1841) is the same as second hash value HV (2, 2, 1) (1941), data management service 235 does not transmit first segment (1, 2, 1) (1801) to data manager 120-B and/or storage 172. Supposing further that data management service 235 determines that first hash value HV (1, 2, 2) (1842) is identical to second hash value HV (2, 2, 2) (1942), data management service 235 determines that there is no need to transmit first segment (1, 2, 2) (1802) to data manager 120-B and/or storage 172.

However, suppose that data management service 235 determines that first hash value HV (1, 2, 3) (1843) is not the same as second hash value HV (2, 2, 3) (1943). Data management service 235 then determines that it is necessary to transmit, to data manager 120-B and/or to storage 172, first segment (1, 2, 3) (1803) of Updated Block 2A (362A), which is associated with first hash value HV (1, 2, 3) (1843).

Data management service 235 may determine that it is necessary to copy other first segments from Updated Block 2A (362A) to data manager 120-B and/or to storage 172, if the corresponding first hash value and the corresponding second hash value are not identical. For example, suppose that data management service 235 also determines that first hash value HV (1, 2, M) (1846) is not the same as second hash value HV (2, 2, M) (1946). Data management service 235 accordingly determines that it is necessary to transmit, to data manager 120-B and/or to storage 172, first segment (1, 2, M) (1806) of Updated Block 2A (362A), which is associated with first hash value HV (1, 2, M) (1846).

In this manner, data management service 235 identifies a plurality of segments that have been changed and that must be copied to data manager 120-B and/or to storage 172 (and one or more segments that have not been changed and do not need to be transmitted). Referring again to FIG. 17, at block 1740, for each changed segment identified in this manner, a determination is made whether or not to divide the changed segment further. Each changed segment may be further segmented and analyzed multiple times, in the manner described above, to achieve a desired degree of granularity. If it is determined that a segment is to be divided further, the method returns to step 1710, and an additional plurality of segments is defined within the segment to achieve a greater degree of granularity.

In the illustrative embodiment, data management service 235 determines that no additional segmentation is necessary. The method thus proceeds to step 1750.

Data management service 235 now determines whether deduplication may be used to further reduce data transmission requirements. Data management service 235 examines the hash values corresponding to first segment (1, 2, 3) (1803) and first segment (1, 2, M) (1806), and determines that the two first segments are identical based on the comparison. Data management service 235 accordingly determines that it is sufficient to transmit to data manager 120-B and/or to storage 172 only one of the two segments, with an instruction to deduplicate the segment.

Referring again to FIG. 17, at step 1750, the changed segment and an instruction relating to the changed segment are inserted into a data packet. Data management service 235 compresses first segment (1, 2, 3) (1803), and inserts the compressed first segment (1, 2, 3) (1803) into a data packet, in the manner described above. Data management service 235 inserts into the header segment of the data packet one or more instructions to decompress the first segment, write first segment (1, 2, 3) (1803) in a location within volume 138 that corresponds to the location of first segment (1, 2, 3) (1803), and deduplicate the data segment to a location within volume 138 that corresponds to first segment (1, 2, M) (1806). Data management service 235 also inserts into the header segment additional information relating to each of the first, second, and third instructions, as appropriate.

At step 1760, information indicating that the data packet requires additional processing is inserted into the data packet. Data management service 235 inserts, into a field within the data packet, information (such as a predetermined sequence of bits), indicating that the data packet requires additional processing. The data packet may be encrypted.

At step 1770, the data packet is inserted into an iSCSI command. Data management service 235 inserts the data packet into an iSCSI command, in the manner described above. At step 1780, the iSCSI command is transmitted. Data management service 235 transmits the iSCSI command to data manager 120-B (or to storage 172).

Data manager 120-B receives the iSCSI command and detects the predetermined sequence of bits within the data packet. Data manager 120-B accordingly extracts the data packet from the command, decrypts the data packet as necessary, and retrieves the compressed first segment (1, 2, 3) (1803) from the data packet. Data manager 120-B examines the instructions (to decompress, write, and deduplicate the first segment), and the related information, and in response decompresses the first segment. Data manager 120-B then writes first segment (1, 2, 3) (1803) at a location associated with second segment (2, 2, 3) (1903), as shown in FIG. 20. Data manager 120-B also deduplicates first segment (1, 2, 3) (1803) to a location associated with second segment (2, 2, M) (1906), as shown in FIG. 20.

In various embodiments, the method steps described herein, including the method steps described in FIGS. 5, 8, 11, 13, 15, and/or 17, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 5, 8, 11, 13, 15, and/or 17, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

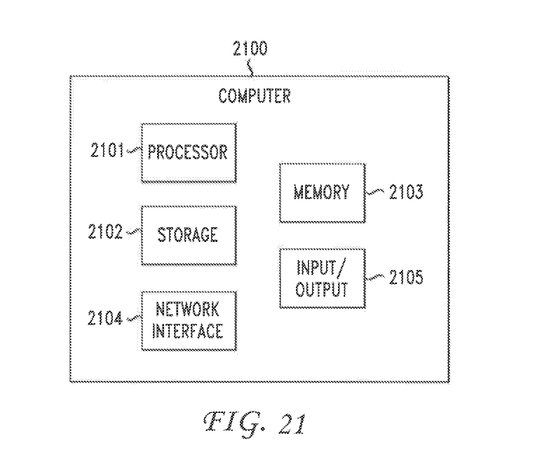

A high-level block diagram of an exemplary computer that may be used to implement systems, apparatus and methods described herein is illustrated in FIG. 21. Computer 2100 includes a processor 2101 operatively coupled to a data storage device 2102 and a memory 2103. Processor 2101 controls the overall operation of computer 2100 by executing computer program instructions that define such operations. The computer program instructions may be stored in data storage device 2102, or other computer readable medium, and loaded into memory 2103 when execution of the computer program instructions is desired. Thus, the method steps of FIGS. 5, 8, 11, 13, 15, and/or 17 can be defined by the computer program instructions stored in memory 2103 and/or data storage device 2102 and controlled by the processor 2101 executing the computer program instructions. For example, the computer program instructions can be implemented as computer executable code programmed by one skilled in the art to perform an algorithm defined by the method steps of FIGS. 5, 8, 11, 13, 15, and/or 17. Accordingly, by executing the computer program instructions, the processor 2101 executes an algorithm defined by the method steps of FIGS. 5, 8, 11, 13, 15, and/or 17. Computer 2100 also includes one or more network interfaces 2104 for communicating with other devices via a network. Computer 2100 also includes one or more input/output devices 2105 that enable user interaction with computer 2100 (e.g., display, keyboard, mouse, speakers, buttons, etc.).

Processor 2101 may include both general and special purpose microprocessors, and may be the sole processor or one of multiple processors of computer 2100. Processor 2101 may include one or more central processing units (CPUs), for example. Processor 2101, data storage device 2102, and/or memory 2103 may include, be supplemented by, or incorporated in, one or more application-specific integrated circuits (ASICs) and/or one or more field programmable gate arrays (FPGAs).

Data storage device 2102 and memory 2103 each include a tangible non-transitory computer readable storage medium. Data storage device 2102, and memory 2103, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 2105 may include peripherals, such as a printer, scanner, display screen, etc. For example, input/output devices 2105 may include a display device such as a cathode ray tube (CRT) or liquid crystal display (LCD) monitor for displaying information to the user, a keyboard, and a pointing device such as a mouse or a trackball by which the user can provide input to computer 2100.

Any or all of the systems and apparatus discussed herein, including server 160, data manager 120-A, data manager 120-B, storage 165, storage 172, and components thereof, including data management service 235 and memory 260, may be implemented using a computer such as computer 2100.

One skilled in the art will recognize that an implementation of an actual computer or computer system may have other structures and may contain other components as well, and that FIG. 21 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method of managing data, the method comprising:
inserting into a data packet an instruction relating to a selected data processing operation and information indicating that additional processing of the data packet is required;
inserting the data packet into a selected field of an iSCSI command; and
transmitting the iSCSI command.

2. The method of claim 1, further comprising:
inserting the information at a predetermined location within the data packet.

3. The method of claim 1, further comprising:
inserting the data packet into a buffer field of the iSCSI command.

4. The method of claim 1, further comprising:
compressing selected data, generating compressed data; and
inserting the compressed data into the data packet.

5. The method of claim 1, further comprising:
encrypting the data packet.

6. The method of claim 1, wherein the instruction relates to one of: a compression operation, a decompression operation, a deduplication operation, a backup operation, a synchronization operation, a write operation, a copy operation, and a snapshot operation.

7. The method of claim 6, wherein the instruction relates to a write operation,
the method further comprising:
inserting into a selected field of the data packet second information indicating a start sector to which data is to be written.

8. The method of claim 6, wherein the instruction relates to a deduplication operation,
the method further comprising:
inserting into a first selected field of the data packet second information indicating a source sector from which data is to be deduplicated; and
inserting into a second selected field of the data packet third information indicating a start sector to which data is to be deduplicated.

9. The method of claim 1, wherein the information comprises one of: a predetermined bit and a predetermined sequence of bits.

10. A method of managing data, the method comprising:
receiving an iSCSI command comprising a data packet;
detecting, in the data packet, first information indicating that additional processing of the data packet is required and second information relating to a specified data processing operation; and
performing the specified data processing operation, based on the second information.

11. The method of claim 10, wherein the data packet is within a buffer field of the iSCSI command.

12. The method of claim 10, wherein the first information is located at a predetermined location within the data packet.

13. The method of claim 10, wherein the first information comprises one of: a predetermined bit and a predetermined sequence of bits.

14. The method of claim 10, wherein the data packet is encrypted,
the method further comprising:
decrypting the encrypted data packet.

15. The method of claim 10, wherein the specified data processing operation comprises one of a compression operation, a decompression operation, a deduplication operation, a backup operation, a synchronization operation, a write operation, a copy operation, and a snapshot operation.

16. The method of claim 15, wherein the second information comprises a first instruction relating to a decompression operation and a second instruction relating to a deduplication operation,
the method further comprising:
performing a decompression operation based on the first instruction; and
performing a deduplication operation based on the second instruction.

17. The method of claim 10, further comprising:
retrieving data from the data packet; and
performing the specified data processing operation with respect to the data, based on the second information.

18. An apparatus comprising:
a memory storing computer program instructions; and
a processor configured to execute the computer program instructions which, when executed on the processor, cause the processor to perform operations comprising:
inserting into a data packet an instruction relating to a selected data processing operation and information indicating that additional processing of the data packet is required;
inserting the data packet into a selected field of an iSCSI command; and
transmitting the iSCSI command.

19. The apparatus of claim 18, the operations further comprising:
inserting the information at a predetermined location within the data packet.

20. The apparatus of claim 18, the operations further comprising:
inserting the data packet into a buffer field of the iSCSI command.

21. The apparatus of claim 18, the operations further comprising:
compressing selected data, generating compressed data; and
inserting the compressed data into the data packet.

22. The apparatus of claim 18, the operations further comprising:
encrypting the data packet.

23. The apparatus of claim 18, wherein the instruction relates to one of: a compression operation, a decompression operation, a deduplication operation, a backup operation, a synchronization operation, a write operation, a copy operation, and a snapshot operation.

24. The apparatus of claim 23, wherein the instruction relates to a write operation,
the operations further comprising:
inserting into a selected field of the data packet second information indicating a start sector to which data is to be written.

25. The apparatus of claim 23, wherein the instruction relates to a deduplication operation,
the operations further comprising:
inserting into a first selected field of the data packet second information indicating a source sector from which data is to be deduplicated; and
inserting into a second selected field of the data packet third information indicating a start sector to which data is to be deduplicated.

26. The apparatus of claim 18, wherein the information comprises one of: a predetermined bit and a predetermined sequence of bits.

27. An apparatus comprising:
a memory storing computer program instructions; and
a processor configured to execute the computer program instructions which, when executed on the processor, cause the processor to perform operations comprising:
receiving an iSCSI command comprising a data packet;
detecting, in the data packet, first information indicating that additional processing of the data packet is required and second information relating to a specified data processing operation; and
performing the specified data processing operation, based on the second information.

28. The apparatus of claim 27, wherein the data packet is within a buffer field of the iSCSI command.

29. The apparatus of claim 27, wherein the first information is located at a predetermined location within the data packet.

30. The apparatus of claim 27, wherein the first information comprises one of: a predetermined bit and a predetermined sequence of bits.
